(19) United States
(12) Patent Application Publication
(10) Pub. No.: US 2024/0379284 A1
(43) Pub. Date: Nov. 14, 2024

(54) TRANSFORMER

(71) Applicant: LITE-ON TECHNOLOGY CORPORATION, Taipei (TW)

(72) Inventors: Kai-De CHEN, Taipei (TW); Yong-Long SYU, Taipei (TW); Chen CHEN, Taipei (TW); Chao-Lin CHUNG, Taipei (TW)

(21) Appl. No.: 18/595,481

(22) Filed: Mar. 5, 2024

(30) Foreign Application Priority Data
May 9, 2023 (TW) 112117133

(51) Int. Cl. H01F 27/30; H01F 27/24; H01F 27/28

(52) U.S. Cl. CPC H01F 27/306; H01F 27/24; H01F 27/2823

(57) ABSTRACT

A transformer including a core structure is provided. The core structure includes a first plate and a second plate opposite to the first plate, two opposite side posts and a plurality of winding posts. At least one of the first plate and the second plate has a first cross-section with a cross-sectional area of Ap. The two side posts are disposed between the first plate and the second plate. At least one of the two side posts has a second cross-section with a cross-sectional area of Ao. The winding posts are disposed between the first plate and the second plate and between the two side posts. At least one of the winding posts has a third cross-section with a cross-sectional area of Ac. 1.5Ac>Ap>0.5Ac, and 0.1Ac<Ao<0.5Ac.

This application claims the benefit of Taiwan application Serial No. 112117133, filed May 9, 2023, the subject matter of which is incorporated herein by reference.

### BACKGROUND OF THE INVENTION

### Field of the Invention

The invention relates in general to a transformer, and more particularly to an integrated multi-column transformer.

### Description of the Related Art

Transformer is an essential element in the supply of power for electronic products. Transformer adjusts an input voltage to a working voltage meeting the requirement of each electronic element. Recently, the miniaturization of switch power has become one of the major trends in development. When transformer is used in a high-power switch power, the core structure of the transformer can seldom maintain a uniform distribution of magnetic flux density.

### SUMMARY OF THE INVENTION

The present invention relates to a transformer, in which the cross-sectional areas of the parts of the core structure form a relationship, so that the uneven distribution of magnetic flux density may be effectively resolved and iron loss is reduced.

According to a first aspect of the present invention, a transformer including a core structure is provided. The core structure includes a first plate and a second plate opposite to the first plate, two opposite side posts and a number of winding posts. At least one of the first plate and the second plate has a first cross-section with a cross-sectional area of Ap. The two side posts are disposed between the first plate and the second plate. At least one of the two side posts has a second cross-section with a cross-sectional area of Ao. The winding posts are disposed between the first plate and the second plate and between the two side posts. At least one of the winding posts has a third cross-section with a cross-sectional area of Ac. 1.5Ac>Ap>0.5Ac, and 0.1Ac<Ao<0.5Ac.

According to one embodiment of the present invention, the quantity of the winding posts is N, and N is an even number greater than 2.

According to one embodiment of the present invention, the winding posts adjacent to each other have opposite magnetic flux directions.

According to one embodiment of the present invention, the length direction of the core structure corresponds to the first axis, the width direction of the core structure corresponds to the second axis, and the thickness direction of the core structure corresponds to the third axis. The normal line of the first cross-section is parallel to the first axis, and the normal lines of the second cross-section and the third cross-section are parallel to the third axis.

According to one embodiment of the present invention, the transformer further includes a winding structure disposed between the first plate and the second plate. The winding structure includes a number of coil winding sets respectively surrounding the winding posts.

According to one embodiment of the present invention, the core structure has a notch disposed on one of the two side posts for the wire to enter and exit the winding structure.

According to one embodiment of the present invention, one of the two side posts and the second plate are integrally formed in one piece, and the notch extends towards the second plate from the upper surface of one of the two side posts.

According to one embodiment of the present invention, the winding posts and one of the first plate and the second plate are separated by a gap.

According to one embodiment of the present invention, the winding posts adjacent to each other are separated by a first distance, the two side posts and the winding post adjacent thereto are separated by a second distance, and the first distance is greater than or equivalent to two times of the second distance.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a transformer according to an embodiment of the present invention;

FIG. 2 is an explosion diagram of the transformer of FIG. 1;

FIG. 3 is a schematic diagram of a winding structure of the transformer of FIG. 1;

FIG. 4 is a partial enlargement of the transformer of FIG. 1;

FIG. 5 is a schematic diagram of a transformer according to another embodiment of the present invention;

FIG. 6 is an explosion diagram of the transformer of FIG. 5;

FIG. 7 a schematic diagram of a winding structure of the transformer of FIG. 5.

### DETAILED DESCRIPTION OF THE INVENTION

The cross-sectional areas of the parts of the core structure of the present invention form a relationship, so that the uneven distribution of magnetic flux density may be effectively resolved and iron loss is reduced.

Detailed descriptions of each embodiment of the present invention are disclosed below with reference to accompanying drawings. Apart from the said detailed descriptions, any embodiments in which the present invention may be used as well as any substitutions, modifications or equivalent changes of the said embodiments are within the scope of the present invention, and the descriptions and definitions in the claims shall prevail. Many specific details and embodiments are disclosed in the specification for anyone ordinary skilled in the art to comprehensively understand the present invention, not for limiting the present invention. Moreover, generally known procedures or elements are not disclosed to avoid adding unnecessary restrictions to the present invention. Designations common to the accompanying drawings are used to indicate identical or similar elements.

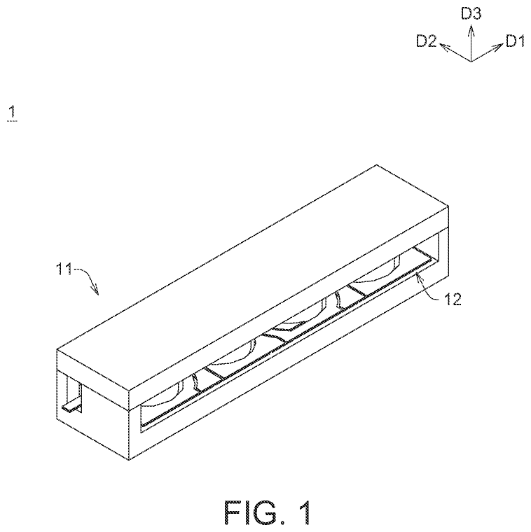

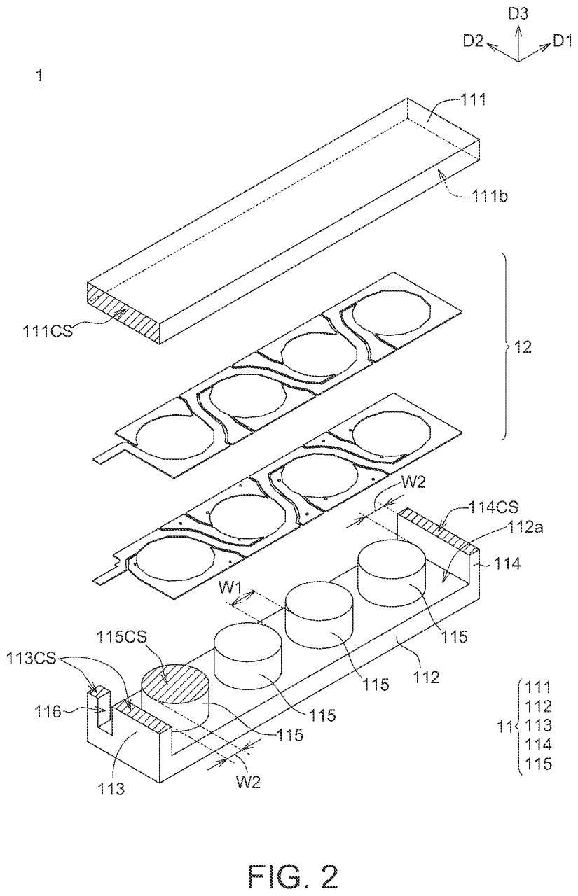

FIG. 1 is a schematic diagram of a transformer according to an embodiment of the present invention. FIG. 2 is an explosion diagram of the transformer of FIG. 1.

Refer to FIG. 1 and FIG. 2. The transformer 1 includes a core structure 11 and a winding structure 12. The core structure 11 includes a first plate 111, a second plate 112, a first side post 113, a second side post 114 and a number of winding posts 115. The first plate 111 is opposite to the second plate 112. The first side post 113 is opposite to the second side post 114 and between the first plate 111 and the second plate 112. A number of winding posts 115 are disposed between the first plate 111 and the second plate 112 and between the first side post 113 and the second side post 114. The long side (parallel to the first axis D1), short side (parallel to the second axis D2) and thickness (parallel to the third axis D3) of the first plate 111 are substantially identical to that of the second plate 112; the long side and the short side respectively correspond to the length and width of the core structure 11. The height (parallel to the third axis D3) of the first side post 113 is substantially identical to that of the second side post 114; the height of the first side post 113 and the second side post 114 and the thickness of the first plate 111 and the second plate 112 respectively correspond to the thickness of the core structure 11. The length direction of the core structure 11 corresponds to the first axis D1; the width direction of the core structure 11 corresponds to the second axis D2; the thickness direction of the core structure 11 corresponds to the third axis D3. The first axis D1, the second axis D2 and the third axis D3 are perpendicular to each other.

As indicated in FIG. 1 and FIG. 2, the first side post 113 and the second side post 114 extend upwards from the upper surface 112a of the second plate 112 along the third axis D3; the first side post 113 and the second side post 114 together with the second plate 112 are integrally formed in one piece and are connected to the first plate 111, but the present invention is not limited thereto. In other embodiments, the first side post 113 and the second side post 114 extend downwards from the lower surface 111b of the first plate 111 along the third axis D3; the first side post 113 and the second side post 114 together with the first plate 111 are integrally formed in one piece and are connected to the second plate 112. Or, one of the first side post 113 and the second side post 114 extends upwards from the upper surface 112a of the second plate 112 along the third axis D3; the one of the first side post 113 and the second side post 114 together with the second plate 112 are integrally formed in one piece and are connected to the first plate 111, the other one of the first side post 113 and the second side post 114 may extend downwards from the lower surface 111b of the first plate 111 along the third axis D3; the other one of the first side post 113 and the second side post 114 together with the first plate 111 are integrally formed in one piece and are connected to the second plate 112.

As indicated in FIG. 1 and FIG. 2, the winding posts 115 extend upwards from the upper surface 112a of the second plate 112 along the third axis D3; the winding posts 115 together with the second plate 112 are integrally formed in one piece, but the present invention is not limited thereto. In other embodiments, the winding posts 115 extend downwards from the lower surface 111b of the first plate 111 along the third axis D3; the winding posts 115 together with the first plate 111 are integrally formed in one piece. The cross-section of the winding posts 115 may have a circular shape. In other embodiments, the cross-section of the winding posts 115 may have other shapes, including but not limited to oval shape or track shape.

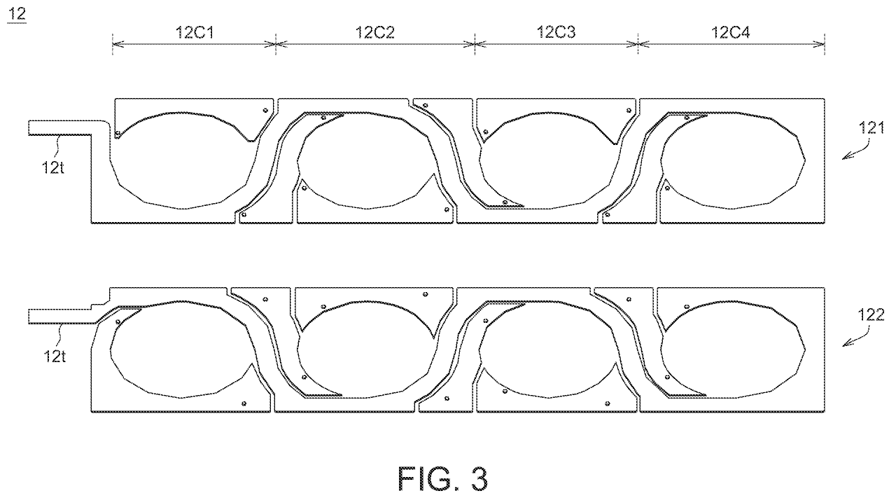

The winding structure 12 is disposed between the first plate 111 and the second plate 112 and surrounds the winding posts 115. Refer to FIG. 2 and FIG. 3, wherein FIG. 3 is the transformer of FIG. 11 [symbol] the winding structure 12 a schematic diagram of. The winding structure 12 includes a first winding layer 121 and a second winding layer 122 stacked together. The winding posts 115 penetrate the first winding layer 121 and the second winding layer 122, so that the winding structure 12 forms a number of coil winding sets 12C1, 12C2, 12C3, 12C4 corresponding to the winding posts 115. The coil winding sets 12C1, 12C2, 12C3, 12C4 may be connected in parallel.

In an embodiment, the winding structure 12 may be realized by a multi-layer circuit board, but the present invention is not limited thereto. For instance, the winding structure 12 may be realized by a metal sheet with conductivity (such as a copper sheet) or a conducting wire.

Refer to FIG. 2 and FIG. 3. The winding structure 12 may be realized by a primary coil, but the present invention is not limited thereto. To simplify the drawings, secondary coils are not illustrated in the present embodiment. In an embodiment, the quantity of winding posts 115 is N, an even number greater than 2. Besides, the magnetic flux directions of two neighboring winding posts 115 are opposite to each other. For instance, the coil may twine two neighboring winding posts 115 clockwise and anti-clockwise respectively; the magnetic flux direction of the winding post 115 twined clockwise faces downwards, and the magnetic flux direction of the winding post 115 twined anti-clockwise faces upwards, so that local magnetic flux cancellation occurs between neighboring winding posts 115. Thus, the winding posts 115 may be tightly integrated in the same transformer 1 to form an integrated multi-column transformer 1 with local magnetic flux cancellation, so that the overall volume of the core structure 11 may be effectively reduced.

To reach the effect of high power using a smaller covered area as indicated in FIG. 2, the distance W1 between two neighboring winding posts 115 is greater than or equivalent to two times of the distance W2 between the first side post 113/the second side post 114 and the winding post 115 adjacent thereto.

Refer to FIG. 2. The first plate 111 has a first cross-section 111CS whose normal line is parallel to the first axis D1. The first side post 113 has a second cross-section 113CS whose normal line is parallel to the third axis D3. The winding posts 115 has a third cross-section 115CS whose normal line is parallel to the third axis D3. In an embodiment, the first cross-section 111CS has a cross-sectional area of Ap, the second cross-section 113CS has a cross-sectional area of Ao, and the third cross-section 115CS has a cross-sectional area of Ac, wherein Ap and Ao meet the following conditions: 1.5Ac>Ap>0.5Ac, and 0.1Ac<Ao<0.5Ac. Thus, the first plate 111, the first side post 113, the winding posts 115 may form a uniform distribution of magnetic flux density; meanwhile, iron loss may be effectively reduced. The transformer 1 of the present embodiment is applicable to an LLC resonant converter; that is, the transformer 1 may be used in the charging pile equipment of electric vehicles and may track the maximum power point of solar energy to provide a circuit architecture for the microgrid system to output voltage.

Refer to Table 1. In comparison to the comparison example where both Ao and Ap are equivalent to 0.5Ac, in an embodiment where Ao is equivalent to 0.4Ac and Ap is equivalent to 0.7Ac, magnetic flux density is uniform, magnetic flux will not have higher density at any specific parts, and iron loss may be reduced by 15%.

TABLE 1

| | Embodiment | Comparison example |
|---|---|---|
| Magnetic flux density of | 130 mT | 200 mT |
| the first plate | | |
| Magnetic flux density of | 145 mT | 100 mT |
| the first side post | | |
| Magnetic flux density of | 150 mT | 150 mT |
| the winding posts | | |
| Iron loss | 4.1 W | 4.8 W |

In the above exemplification, the first cross-section 111CS is a longitudinal section of the first plate 111, the second cross-section 113CS is a cross-section of the first side post 113, and the third cross-section 115CS is a cross-section of one of the winding posts 115. However, the first cross-section may be a longitudinal section of the second plate 112, the second cross-section may be a cross-section of the second side post 114, and the third cross-section may be a cross-section of other winding posts 115. That is, the second plate 112, the second side post 114, and the winding posts 115 also may form a uniform distribution of magnetic flux density.

As indicated in FIG. 2 and FIG. 3, the core structure 11 has a notch 116 disposed on the first side post 113 and used for the winding wire 12t to enter and exit the winding structure 12. As indicated in FIG. 2, in the present embodiment, the notch 116 is a recess extending downward from the upper surface of the first side post 113 (that is, extending towards the second plate 112 in a negative direction of the third axis D3), and the notch 116 may expose the upper surface of the second plate 112. The width of the first side post 113 (parallel to the first axis D1) may be slightly greater than the second side post 114, so that the cross-sectional area of the second cross-section 113CS of the first side post 113 is substantially identical to that of the second cross-section 114CS of the second side post 114. Thus, the disposition of the notch 116 on the first side post 113 will not affect the distribution of magnetic flux density or cause an increase to iron loss. In other embodiments, the notch 116 may be disposed on the second side post 114; or, the notch 116 may be disposed on both the first side post 113 and the second side post 114. In other embodiments, the notch may be a hole, which is formed on the first side post 113 or the second side post 114 and allows the winding wire of the winding structure 12 to pass through, and the notch does not have to be recessed from the upper surface of the first side post 113 or the second side post 114.

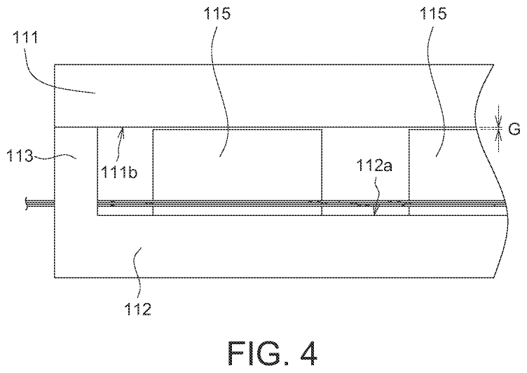

FIG. 4 is a partial enlargement of the transformer 1 of FIG. 1. Refer to FIG. 4. The first plate 111 and the winding posts 115 may be separated by a gap G. The gap G is formed between the lower surface 111b of the first plate 111 and the winding posts 115 and is used to adjust the inductance of the transformer 1. In an embodiment, the gap G may be formed between the second plate 112 and the winding posts 115. That is, the winding posts 115 may be formed on the lower surface 111b of the first plate 111, and the gap G may be formed between the upper surface 112a of the second plate 112 and the winding posts 115. In other embodiments, the winding posts 115 and the first plate 111/the second plate 112 do not have to be separated by a gap G.

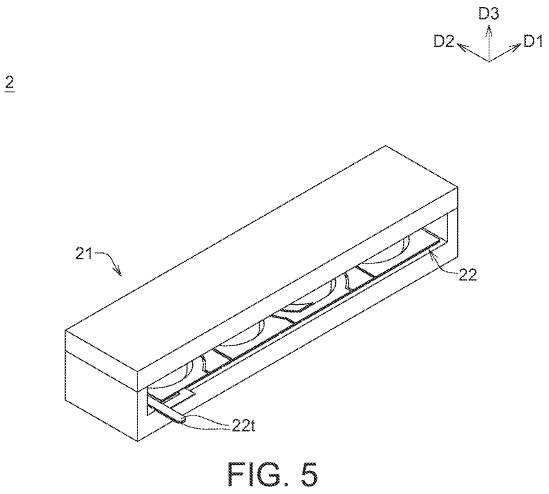

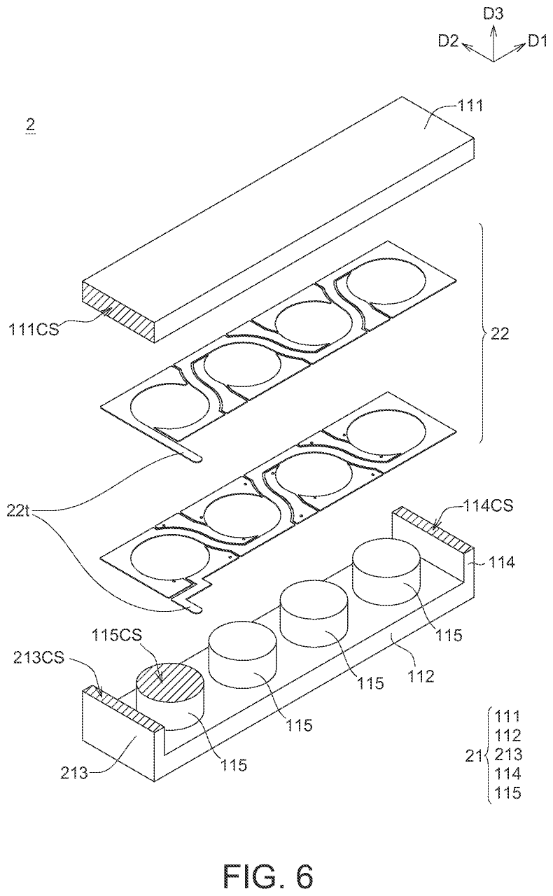

FIG. 5 is a schematic diagram of a transformer 2 according to another embodiment of the present invention. FIG. 6 is an explosion diagram of the transformer 2 of FIG. 5. One of the differences between the transformer 2 of FIG. 5 and the transformer 1 of FIG. 1 lies in the design of the core structure 21 and the winding structure 22.

Refer to FIG. 5 and FIG. 6. In an embodiment of the present, the first side post 213 and/or the second side post 114 do not have the notch via which the wire enters and exits the winding structure 22, and the winding wire 22t of the winding structure 22 may directly enter and exit via the two sides of the second axis D2.

Similarly, the first cross-section 111CS of the first plate 111 has a cross-sectional area of Ap, the second cross-section 213CS of the first side post 213 has a cross-sectional area of Ao, and the third cross-section 115CS of one of the winding posts 115 has a cross-sectional area of Ac, wherein Ap and Ao meet the following conditions: 1.5Ac>Ap>0.5Ac, and 0.1Ac<Ao<0.5Ac. Thus, the first plate 111, the first side post 213, and the winding posts 115 may form a uniform distribution of magnetic flux density; meanwhile, iron loss may be effectively reduced. Since the first side post 213 and/or the second side post 114 do not have a notch via which the wire enters and exits the winding structure 22, the cross-sectional area of the second cross-section 213CS of the first side post 213 is substantially identical to that of the second cross-section 114CS of the second side post 114.

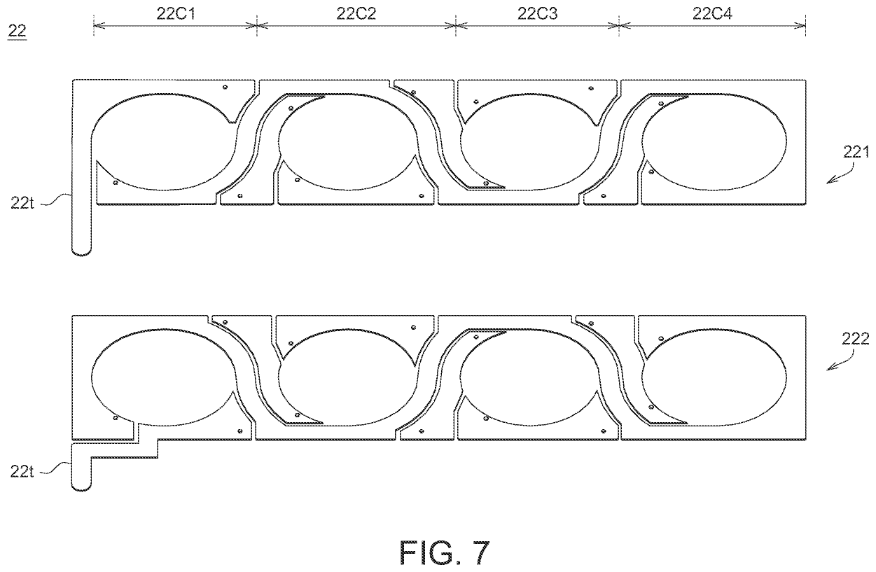

FIG. 7 is a schematic diagram of a winding structure 22 of the transformer 2 of FIG. 5. Refer to FIG. 6 and FIG. 7. Like the winding structure 12 of FIG. 3, the winding structure 22 includes a first winding layer 221 and a second winding layer 222 stacked together. The winding posts 115 penetrate the first winding layer 221 and the second winding layer 222, so that the winding structure 22 forms a number of coil winding sets 22C1, 22C2, 22C3, 22C4 corresponding to the winding posts 115. The coil winding sets 22C1, 22C2, 22C3, 22C4 may be connected in parallel.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A transformer comprising:
a core structure comprising:
a first plate and a second plate opposite to the first plate, wherein at least one of the first plate and the second plate has a first cross-section with a cross-sectional area of Ap;
two side posts disposed between the first plate and the second plate and opposite to each other, wherein at least one of the two side posts has a second cross-section with a cross-sectional area of Ao; and
a plurality of winding posts disposed between the first plate and the second plate and between the two side posts, wherein at least one of the winding posts has a third cross-section with a cross-sectional area of Ac;
wherein 1.5Ac>Ap>0.5Ac, and 0.1Ac<Ao<0.5Ac.

2. The transformer according to claim 1, wherein a quantity of the winding posts is N, and N is an even number greater than 2.

3. The transformer according to claim 1, wherein the winding posts adjacent to each other have opposite magnetic flux directions.

4. The transformer according to claim 1, wherein a length direction of the core structure corresponds to a first axis, a width direction of the core structure corresponds to a second axis, a thickness direction of the core structure corresponds to a third axis, a normal line of the first cross-section is parallel to the first axis, and normal lines of the second cross-section and the third cross-section are parallel to the third axis.

5. The transformer according to claim 1, further comprising a winding structure disposed between the first plate and the second plate, wherein the winding structure comprises a plurality of coil winding sets respectively surrounding the winding posts.

6. The transformer according to claim 5, wherein the core structure has a notch disposed on one of the two side posts for a wire to enter and exit the winding structure.

7. The transformer according to claim 6, wherein the one of the two side posts and the second plate are integrally formed in one piece, and the notch extends towards the second plate from an upper surface of the one of the two side posts.

8. The transformer according to claim 5, wherein the winding structure is a multi-layer circuit board.

9. The transformer according to claim 1, wherein the winding posts and one of the first plate and the second plate are separated by a gap.

10. The transformer according to claim 1, wherein the winding posts adjacent to each other are separated by a first distance, the two side posts and one of the winding posts adjacent thereto are separated by a second distance, and the first distance is greater than or equivalent to two times of the second distance.
